(19) United States
(12) Patent Application Publication
(10) Pub. No.: US 2014/0042781 A1
(43) Pub. Date: Feb. 13, 2014

(54) VEHICLE SEAT AND TRIM

(71) Applicant: Lisa Reeves, Cheshire (GB)

(72) Inventor: Lisa Reeves, Cheshire (GB)

(73) Assignee: BENTLEY MOTORS LIMITED, Cheshire (GB)

(21) Appl. No.: 14/113,830

(22) PCT Filed: Apr. 26, 2012
(86) PCT No.: PCT/GB12/50918

§ 371 Date: Oct. 25, 2013

(30) Foreign Application Priority Data
Apr. 27, 2011 (GB) 1107061.2

(51) Int. Cl. B60R 7/04; B60N 3/00

(52) U.S. Cl. CPC B60R 7/043; B60N 3/004
USPC 297/163; 297/188.07

(57) ABSTRACT

A vehicle seat (10) has a back rest (12), with a rear face provided with a pocket (15) in which items may be stored. A cover flap (19) is provided and is movable between a lowered position in which it covers an opening of the pocket and a raised position for allowing access to the pocket. In the raised position at least part of the cover flap extends generally parallel to the rear face of the seat back. A catch arrangement (20) releasably holds the cover flap in the raised position. An additional pocket (25) may be provided on the cover flap and accessible when the cover flap is open.

### TECHNICAL FIELD OF THE INVENTION

The present invention relates to a vehicle seat with a pocket in the back rest, particularly but not exclusively an automotive vehicle seat.

### BACKGROUND TO THE INVENTION

Vehicle interiors fulfil a dual role in providing safety for the occupants of the vehicle as well as comfort. This includes providing storage space liar the ever increasing number or essential objects that a person may carry with them. In particular, there is an increase of personal electronic devices being used and carried by people. Storage space in a vehicle is at a premium, particularly for occupants in the back seats or a vehicle who are unable to directly access many of the conventional storage compartments of a vehicle during travel. This includes for example the glove compartment, compartments located on the dashboard or centre console of a car, or even side pockets in the front doors or storage spaces under the headliner.

It is accordingly an object of embodiments of the present invention to provide a means for occupants in the hack seat of a vehicle to store personal items, including personal electronic items.

During travel, it is often desirable for occupants in a car to be able to access or use their personal items and personal electronic devices in a convenient and comfortable manner.

It is therefore a further object of embodiments of the present invention to provide a means for an occupant in the back seat of a vehicle to conveniently and comfortably access personal electronic devices and other items.

Theft from vehicles, in particular theft of personal electronic devices, is an ever present risk. The risk is especially high if a vehicle is parked in a publicly accessible or unsupervised location.

It is therefore also an object of embodiments of the present invention to provide a way of storing personal electronic devices out of sight of would-be thieves passing by a vehicle.

### SUMMARY OF THE INVENTION

According to a first aspect of the invention there is provided, a vehicle seat having a back rest, said back rest comprising:

a pocket in or on a rear face of said back rest;
a cover flap, said cover flap being movable between a lowered position in which it covers an opening of said pocket and a raised position, in which at least part of it extends generally parallel to the rear race of the back rest, for allowing access to said pocket; and,
a catch arrangement for releasable holding said cover flap in said raised position.

Most or substantially all of the cover flap may extend generally parallel to the rear face of the back rest when in the raised position.

The cover flap may be attached to the back rest for movement between the raised and lowered positions about a line or attachment. The line of attachment may be substantially horizontal and located above the pocket.

The catch arrangement may use any suitable means for reliably and releasably holding said cover flap in the raised position, including but not limited to magnetic, electromagnetic, mechanical, or chemical. In a preferred embodiment said catch is a magnetic catch.

The catch arrangement may comprise a catch member on the flap and a corresponding engagement member on the rear of the seat back. The catch member may be located on the outside of said cover flap. The outside of the cover flap being the side which is directed away from the back rest when the cover flap is in the lowered position, the inner side of the cover flap being the side which is directed towards the back rest in the locked position.

The catch arrangement may be located towards a free edge of the cover flap.

The back rest may include a folding tray table on the rear face of the back rest above the pocket, in which case, the engagement member may be provided on or form part of said folding tray table. In particular, the engagement member may be part of or attached to an edge of the tray table which is uppermost when the table is in a folded condition for engagement with the catch member. The engagement member may comprise a recess in the uppermost edge of the table in which the catch member is received. One of the catch member and the table may incorporate a permanent magnet and the other of the catch member and the table may comprise a magnetic material to which the magnet is attracted when the catch member is located in the recess to releasably hold the catch member in the recess.

A second pocket may be provided on an inside of said cover flap. The second pocket may be configured to releasably hold at least one personal electronic device such as a mobile phone, personal organiser, digital music player or the like. The second pocket may be configured so that it is open in an upward direction when the flap is in the raised position.

The cover flap may be configured to extend substantially parallel to the rear face of the back rest when in a lowered position. The vehicle seat may also have a catch arrangement for releasably holding the flap in the lowered position. This may comprise a further engagement member for co-operation with the catch member on the cover flap.

The seat may be configured so that there is a gap between, at least a lower portion of the flap and the rear face of the back rest when the flap is held in the raised position by the catch arrangement. The arrangement is such that an item, such as a rolled up newspaper or the like, can held between the flap and the rear lace of the back rest when the flap is held in the raised position by the catch arrangement.

The pocket may be of any suitable shape or dimensions but is preferably generally rectangular and open along an upper edge for insertion of items into the pocket. The pocket may be dimensioned to receive a laptop computer, notebook, notepad or the like. The pocket may be defined between an inner and an outer panel of the trim of the back rest. All or part of the upper edge of outer panel may not be secured to the inner panel to form the opening into the pocket. The upper edge of the outer panel may be substantially straight or it may be profiled to facilitate access to said pocket. In a preferred embodiment, the outer panel has a substantially U-shaped cut-out in an upper region which defines an opening to the pocket. Further, either or both of the inner and outer panels may be lined.

The cover nap may be flexible and may be formed from a flexible sheet material, such as leather, hide or like material.

According to a second aspect of the invention, there is provided a seat trim for the back rest of a vehicle seat, said seat trim comprising;

a pocket provided in or on a rear face of the back rest trim;
a cover flap, said cover flap being movable between a lowered position for covering, an opening of said pocket and a raised position for allowing access to said pocket;
and a catch arrangement for releasably holding said cover flap in at least said raised position, the trim being configured so that in use, when fitted to the backrest of a vehicle seat, when the cover flap is in the raised position at least part of it extends generally parallel to a rear lace of the backrest.

Most or substantially all of the cover flap may extend generally parallel to the rear face of the back rest when in the raised position,

The seat trim may be adapted for use with a vehicle seat in accordance with the first aspect of the invention.

In order that the invention may be more clearly understood an embodiment thereof will now be described, by way of example only, with reference to the accompanying drawings, of which:

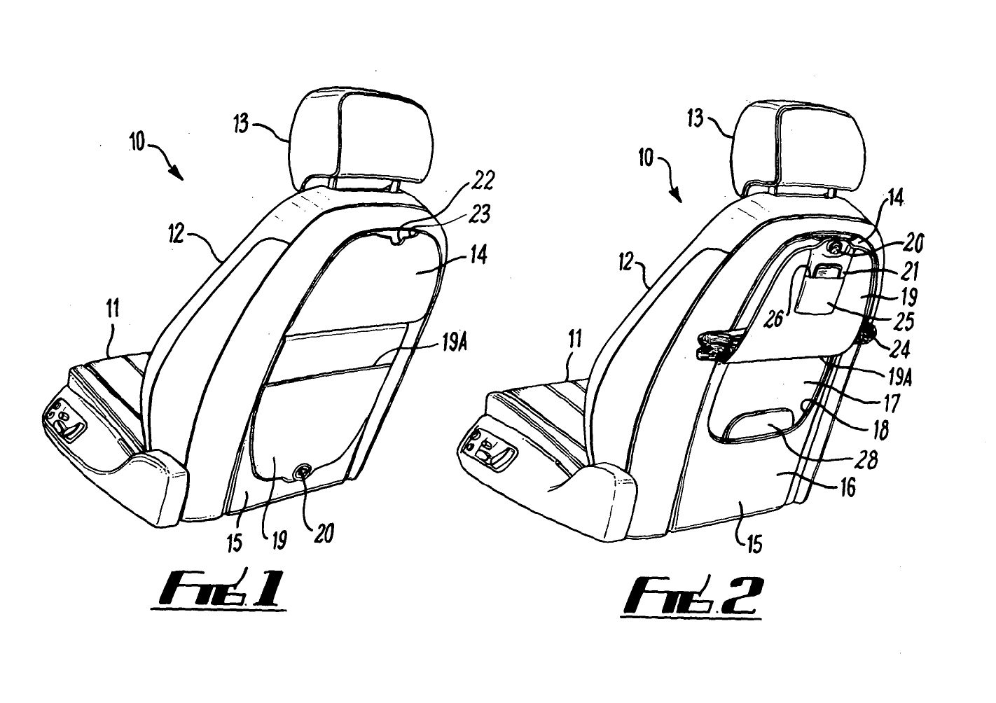

FIG. 1 is a perspective view from the rear and to one side of a vehicle seat in accordance with the invention, showing the seat with a cover flap for a pocket in a. lowered position.

FIG. 2 is similar to FIG. 1, but shows the cover flap in a raised position,

### DETAILED DESCRIPTION OF THE INVENTION

FIGS. 1 and 2 show a vehicle seat 10 according to the present invention. Said seat 10 has a seat cushion 11, a back rest 12, and a head rest 13, On the rear of said back rest, a folding tray table 14 is provided. The table 14 may be moved between a folded up position, as shown, and a folded down position in which it extends away from the backrest to provide a surface on which items can be placed in a known manner. In the folded up position, the table 14 is substantially in line with the back rest so as to minimize storage space needed.

Below the folding table 14, the rear of the back rest 12 is provided with a pocket 15 in which personal items may be placed for storage. The pocket is formed as an integral part of the trim of the back rest and is defined between an outer panel 16 and an inner panel 17 of the trim. The outer panel 16 is substantially rectangular and is attached along two vertical side edges and a lower horizontal edge to the inner panel 17 by any suitable method. For example, the outer panel 16 could be attached by means of stitching, or by means of an adhesive, or even welding if the materials are compatible. The outer panel 16 has a substantially U-shaped aperture 18 in an upper region which forms an opening into the pocket.

Also provided on the rear of said back rest is a cover flap 19 for selectively closing the pocket. The cover flap 19 is made of a flexible material, such as leather, and is attached to the inner panel 17 of the back rest trim along a horizontal line 19A just above the uppermost edge of the outer panel 16. As with the outer panel 16, the cover flap 19 can be attached to the inner panel 17 by any suitable method including any or those discussed above in relation to the outer panel 16. The cover flap 19 is sufficiently flexible that it can be pivoted or flexed around the line of attachment 19A between a lowered position as shown in FIG. 1 and a raised position as shown in FIG. 2. The cover flap 19 is configured so that when it is in the lowered position, it extends downwardly from the line of attachment generally parallel to the rear face of back rest to cover the opening 18 of the pocket 15. In the raised position as shown in FIG. 2, the flap extends upwardly from the line of attachment 19A, generally parallel to the rear face of the back rest, to allow easy access to the pocket opening 18. The pocket 15 can be dimensioned and shaped as desired but may conveniently be configured to hold a larger personal electronic device such as a laptop computer 28, notebook, notepad or the like.

In this embodiment the cover flap 19 is styled to give the appearance of a traditional satchel type bag when it is in the lowered position overlying the pocket 15.

To allow a rear seat passenger unhindered access to the pocket 15 during a trip or when otherwise seated in the vehicle, a magnetic catch arrangement is provided to hold the cover flap in the raised position. The catch arrangement includes a catch member 20 which is attached centrally to a free edge portion 21 of the cover flap. The catch arrangement also includes an engagement member 22 on the rear face of the back rest with which the catch member 20 co-operates to hold the flap in the raised position. In the present embodiment, the engagement member 22 is conveniently formed as part of the folding table. Thus an edge 23 of the table which is uppermost when the table is folded away is profiled to provide a recess 22 in which the catch member locates when the flap is moved to the raised position. The table, or at least the upper edge region where the catch member engages, is made of or incorporates a magnetic metal material, such as steel, and the catch member includes one or more permanent magnets which are attracted to the table 14 to hold the flap in the raised position to releasably hold the catch member in the recess. In this embodiment, the catch member 20 is circular and the recess 22 is semi-circular but other suitable shapes can be adopted.

It will be appreciated that other catch arrangements can be adopted to hold the flap in the raised position. For example, the catch member 20 could be made of a magnetic metal and one or more permanent magnets provided in the edge of the table. In a further alternative, permanent magnets of opposite pole may be provided on the catch member 20 and the table. Indeed the catch arrangement need not be magnetic at all but could be a mechanical, electromagnetic or indeed a chemical catch arrangement. It should also be noted that the pocket 15 and cover flap 19 arrangement of the present invention can be used with seats not having a folding table 14, in which case a separate catch engagement member 22 will be provided on the rear of the back rest at a suitable location.

When in the raised position, the cover flap 19 is spaced from the rear face of the back rest 12 of the vehicle seat. This space may be used to temporarily hold objects such as a folded up newspaper 24 or the like as illustrated in FIG. 2. Most of the length of the cover flap 19, extending from its line of attachment 19A to the seat back to its free edge towards the catch 20, extends substantially parallel to the rear face of the seat back.

To further increase the storage options for a rear seat passenger, one or more further pockets 25 can be provided on an inner side of the cover flap 19 so as to be accessible to a rear seat passenger when the flap 19 is held in the raised position. In the present embodiment, a second pocket 25 is located centrally near the free edge of the flap 19. The second pocket 25 is open along an edge 26 which is uppermost when the cover flap 19 is in the raised position so that a rear seat passenger can place items in the pocket 25 for temporary storage. The second pocket 25 can be dimensioned and shaped as desired and may conveniently be configured to hold a personal electronic. device 27, such as a mobile phone, personal organiser, digital music player or the like, which can be placed in the pocket where it is easily accessible during a journey. The second pocket 25 may itself be provided with a closable cover flap or other means of securing an item in the pocket so that the item can be securely retained even when the cover flap 19 is moved to the lowered position.

The cover flap may be arranged to simply hang down covering the opening 18 of the pocket 15 when in the lowered position. The weight of the catch member 20 may assist in holding the flap close to the rear face of the back rest when in the flap is in the lowered position. Alternatively, a further engagement member can be provided for engagement with the catch member 20 to hold the flap in the lowered position. Other arrangements for holding the cover flap 19 in the lowered position could also be adopted, such as the use of hook and loop type fastener, for example.

The pocket and cover flap arrangement of the present invention provides a simple, yet flexible storage facility for rear seat passengers. With the cover flap 19 held in the raised position, items, such as a laptop computer 28, can be easily inserted into and removed from the main pocket 15 and further items can be located in the second pocket 25 or between the flap and the back rest. When the cover flap 19 is lowered, it provides a very clean and attractive appearance to the rear or the vehicle seat with minimal intrusion in to the rear passenger space. In this lowered position, the cover flap 19 also hides from view any articles contained in the main pocket 15 so that they are not visible to a potential thief.

The above embodiment is described by way of example only. Many variations are possible without departing from the scope Of the invention as defined by the appended claims.

1. A vehicle seat having a back rest, said back rest comprising:
a pocket in or on a rear face of said back rest;
a cover flap, said cover flap being movable between a lowered position, in which it extends generally parallel to the rear face of the back rest and covers an opening of said pocket, and a raised position, in which at least part of it extends generally parallel to the rear face of the back rest, for allowing access to said pocket; and,
a catch arrangement for releasably holding said cover flap in said raised position.

2. A vehicle seat according to claim 1, wherein said cover flap is attached to said back rest along a straight attachment line.

3. A vehicle seat according to claim 2, wherein said straight attachment line is horizontal.

4. A vehicle seat according to claim 1, wherein said catch arrangement comprises a magnetic catch.

5. A vehicle seat according to claim 1, wherein the catch arrangement comprises a catch member on the flap and a corresponding engagement member on the rear of the seat back.

6. A vehicle seat according to claim 5, wherein the catch member is located on the outside of said cover flap.

7. A vehicle seat according to claim 5, wherein a folding tray table is provided on said back rest above the pocket, and said engagement member is provided on or forms part of said folding tray table.

8. A vehicle seat according to claim 1, wherein a second pocket is provided on an inside of said cover flap.

9. A vehicle seat according to claim 8, wherein said second pocket is configured to releasably hold at least one personal electronic device.

10. A vehicle seat according to claim 8, wherein said second pocket is open in an upward direction when the flap is in the raised position.

11. (canceled)

12. A vehicle seat according to claim 1, wherein there is a gap between at least a lower portion of the flap and the rear face of the back rest when the flap is held in the raised position by the catch arrangement.

13. A vehicle seat according to claim 12, wherein the arrangement is such that an item can be held between the flap and the rear face of the back rest when the flap is held in the raised position by the catch arrangement.

14. A vehicle seat according to claim 1, further comprising a catch arrangement for releasably holding the flap in the lowered position.

15. A vehicle seat according to claim 1, in which the pocket is dimensioned to receive a laptop computer, notebook, notepad or the like.

16. A vehicle seat according to claim 1 in which the cover flap is flexible.

17. A seat trim for the back rest of a vehicle seat, said seat trim comprising:
a pocket provided in or on a rear face of the back rest trim;
a cover flap, said cover flap being movable between a lowered position for covering an opening of said pocket and a raised position for allowing access to said pocket;
and a catch arrangement for releasably holding said cover flap in at least said raised position, the trim being configured so that in use, when fitted to the backrest of a vehicle seat, when the cover flap is in the raised position at least part of it extends generally parallel to a rear face of the backrest and when the cover flap is in the lowered position it extends generally parallel to the rear face of the backseat.
